(19) United States
(12) Patent Application Publication
(10) Pub. No.: US 2016/0111004 A1
(43) Pub. Date: Apr. 21, 2016

(54) METHOD AND DEVICE FOR DYNAMIC MANAGEMENT OF URBAN MOBILITY

(71) Applicant: INEO, Paris La Defense Cedex (FR)

(72) Inventor: GUILLAUME DELMAS, VAURÉAL (FR)

(73) Assignee: INEO, PARIS LA DEFENSE CEDEX (FR)

(21) Appl. No.: 14/786,527

(22) PCT Filed: Apr. 19, 2014
(86) PCT No.: PCT/EP2014/058029

§ 371 Date: Oct. 22, 2015

(30) Foreign Application Priority Data
Apr. 22, 2013 (FR) 13 53661

(51) Int. Cl. G08G 1/14

(52) U.S. Cl. CPC G08G 1/147

(57) ABSTRACT

A method and its implementation device to supervise the parking of vehicles in a geographic domain. The instantaneous occupancy status of the parking area of the geographic domain is obtained at a time t. The instantaneous turnover rate of parking in the parking area is obtained at the time t. The future occupancy rate is computed at a time (t+Δt) and its probability from the instantaneous occupancy status and the instantaneous turnover rate at the time t. The future occupancy rate or the future occupancy probability is provided if either is below or above a predefined threshold. The device and method guides motorists to available parking spaces and optimizes the enforcement of the parking area, particularly by on-street parking enforcement officers.

This invention relates to a method and a device for the dynamic management of urban mobility. The invention is particularly but not exclusively intended for supervising and anticipating the parking of automotive vehicles in an urbanized area. The invention is more particularly suitable for supervising on-street parking and is thus intended for a city or an urbanized area where the share of on-street parking is the largest or more significant, which, in France, means most of the cities with populations below 100,000. That is because in larger cities, parking is mostly organized in off-street parking facilities. However, the invention is also suitable for supervising off-street parking, more specifically combined parking situations that make up most of its applications.

Throughout the text, the term ‘off-street parking’ refers to a parking organized in demarcated spaces in an enclosed area where access is controlled, whether the parking facility is overhead, underground or above ground. The term ‘on-street parking’ refers to a parking in an open area, whether paid for or free of charge, in spaces that may or may not be demarcated.

The term ‘parking area’ means the entire parking offer in a given geographic domain, combining off-street and on-street parking, whether paid or free of charge.

Even though it is a source of significant operating revenue and it has a direct effect on the flow of vehicles in a town, parking, particularly on-street parking, is poorly supervised because it is technically complex to anticipate and identify. The ability to supervise parking in a town has at least three aims:
allowing road users to go rapidly to available spaces and thus limit the redundant flow of vehicles;
allowing public authorities to adapt the supply and demand depending on various constraints;
optimizing operating revenue and the efficiency of on-street parking enforcement staff.

Document EP 1 128 350 describes a method, based on indications from parking terminals and historical statistics, to anticipate the parking occupancy rate of an urban sector and thus supply information to road users about the availability of spaces in that area. That method of the prior art has several limitations. First of all, there is no direct match between the number of parking tickets issued by a terminal and the effective occupancy rate of the sector covered by said terminal, or between the parking time paid and the effective parking time of a vehicle. Further, the system is limited to streets with demarcated spaces; such demarcation being not always respected by road users. Finally, nothing prevents a motorist from securing a parking ticket from a terminal covering another sector. These difficulties are partly solved by that method of the prior art by correcting the objective data provided by the terminals using statistical data obtained from the observation of behavior. Consequently, this system is unsuitable for cases resulting from unusual situations where it would be most useful. In view of the three needs stated above, this method of the prior art only addresses the first one, that of the motorist.

The document EP 2 082 386 describes a method for supervising on-street parking, particularly suited for parking without demarcated spaces. That device relies on interaction between the motorist and a supervision system, where the motorist reports to said system firstly the length of his vehicle and secondly his choice of parking sector once he gets there. When considered along with the previous method of the prior art, this one only solves the issue of the non-demarcation of parking spaces and has the same limitations overall.

Those methods of the prior art, which obtain their information from the payment of parking fees by motorists, are tricky to implement in the presence of a plurality of payment methods. Indeed, it is not rare for several payment methods to be used within the same city, including terminals, cards, residents' cards, telephone payment etc. Further, while these methods of the prior art show some efficiency in guiding motorists within the same sector or within several sectors close to each other, they are not as efficient for a city as a whole. Indeed, the usefulness for a motorist to reach a sector with available parking space depends on the time it takes to reach that sector. Thus, a sector with many available spaces could be fully occupied by the time the motorist reaches it, if that sector has been recommended to a large number of motorists capable of getting there earlier. Conversely, it is sometimes wiser to guide a motorist to a sector with fewer available spaces, but where the turnover is liable to offer a greater probability of finding a parking space.

This invention aims to solve the drawbacks of the prior art and relates to that end to a method for supervising the parking of vehicles in a geographic domain, wherein said method includes steps consisting in:
a. obtaining the instantaneous occupancy status of the parking area of said geographic domain at an instant t;
b. obtaining the instantaneous turnover rate of parking over a period T in said parking area at an instant t;
c. computing, from the data collected in steps (a) and (b), the future occupancy rate at an instant (t+Δt) and its probability;
d. providing information when the probability or the occupancy rate determined in step (c) is below or above a definite threshold.

Throughout the text, the term ‘turnover rate’ means, for a given geographic domain, the average number of vehicles that successively occupy a space over a given period.

Thus, the occupancy rate of the concerned parking area is determined dynamically, along with its probability of occurrence. That information particularly makes it possible to contextualize and weight the occupancy information on the basis of geographical data, such as the journey time up to the geographic domain in question, or on the basis of a particular event condition, for both real-time supervision and simulation purposes. The information provided in step (d) may be used, after appropriate formatting, both by road users and by on-street parking enforcement officers or public authorities in order to optimize the occupancy of the geographic domain or optimize the operating revenue from the associated parking area.

The invention can be implemented advantageously in the embodiments described below, which may be considered individually or in any technically operative combination.

Advantageously, step (a) comprises the steps consisting in:
ai. obtaining the number of vehicles present instantaneously in the geographic domain;
aii. obtaining the instantaneous number of vehicles in transit in said geographic domain;
aiii. determining the number of vehicles parked in the geographic domain by subtracting the number obtained in step (aii) from the number obtained in step (ai).

Thus, the method according to the invention makes it possible to determine the occupancy rate of the parking area independently from the payment of fees and compliance with parking areas. Further, this embodiment is implemented without individual space-based parking detection means, as it only requires sequential counting beacons. Thus, this embodiment of the method according to the invention can be implemented easily in an urban area without major road works and with reduced investment.

Advantageously, step (b) comprises the steps consisting in:
bi obtaining the spatial occupancy rate of the geographic domain via the number of vehicles parked in said domain at an instant t;
bii. determining the time occupancy rate of said domain over a period T, via the average spatial occupancy rate over that period;
biii. determining the turnover rate of said geographic domain by averaging, over the period T, the variation of the time occupancy rate determined in step (bii).

Thus, the method according to the invention is based on a turnover rate that is constantly updated, and is computed, if needed, with different periods of integration.

Advantageously, step (c) is determined on the basis of a journey time At to the geographic domain using an optimization metaheuristic. Thus, the information provided is, for its recipient, the optimum at an instant t. The choice of an optimization metaheuristic makes it possible to rapidly address the complex optimization problem.

According to one particular embodiment, the metaheuristic uses a random proportional transition rule derived from an ant colony algorithm and the information provided in step (d) is built from the visibility of the geographic domain at the time (t+Δt). That choice of optimization algorithm is particularly suitable for addressing the problem. The use of the visibility of the geographic domain as the conditional parameter for display makes it possible to display only pertinent information, particularly for motorists.

Advantageously, step (aii) includes determining the average speed of vehicles in part of the geographic domain and determining the dominant time frequency of entry in said part of the domain at an instant t. The applicant has indeed determined that the derivative of the vehicle counting function in a given geographic zone is a finite-variance function that can be broken down into a sum of sinusoidal functions. Thus, the determination of the number of vehicles that are simultaneously in transit in said geographic zone is greatly facilitated, using the passage frequencies with the highest spectral density, while improving the robustness of the algorithm.

In an advantageous embodiment, the method according to the invention comprises the steps consisting in:
e. obtaining a parking tariff grid in the geographic domain;
f. determining the theoretical revenue at an instant t, for a period T depending on the occupancy rate of the domain determined in step (bii).

Thus, the method according to the invention makes it possible, in this embodiment, to simulate the revenue generated depending on the conditions of occupancy of the area according to the selected tariff grid. The result of step (f) is obtained independently from the effective payment of parking fees in the geographic domain in question.

Advantageously, the method according to the last embodiment of the invention comprises the steps consisting in:
g. obtaining the effective revenue of the corresponding domain at an instant t over a period of observation T;
h. determining the payment rate of the geographic domain in question over a given period by comparing, in that period, the relationship between the instantaneous results of steps (g) and (f).

Thus, the method according to the invention makes it possible to supervise and enforce the payment of parking fees, particularly in order to maximize revenue and improve the effectiveness of enforcement.

Advantageously, the method according to the invention comprises, in this last embodiment, steps consisting in:
j. combining the information obtained in step (c) with the information obtained in step (h) and determining the future payment rate at an instant (t+Δt) and its probability;
k. providing information if the probability or rate of payment determined in step (j) are below or above a given threshold.

Thus, the method according to the invention provides contextualized geographic information of the payment rate in the parking area in order to anticipate the steps to be taken.

Advantageously, step (j) is determined on the basis of a journey time Δt of an on-street parking enforcement officer to the geographic domain using optimization metaheuristics, based on a random proportional transition rule derived from an ant colony algorithm, where the information provided in step (k) is built from the visibility of the geographic domain at a time (t+Δt). Thus, the method according to the invention makes it possible to optimize the work of enforcement officers by taking account complex problems.

In a particular embodiment, the method according to the invention comprises a step consisting in:
l. modifying the tariff grid depending on the occupancy rate determined in step (a) or the theoretical revenue determined in step (f).

Thus, the method according to the invention makes it possible to offer dynamic tariff management, particularly in order to optimize the occupancy of the parking area by an offer that acts as an incentive or a deterrent.

The invention also relates to a device for implementing the method according to the invention in any of its embodiments, which device comprises:
i. a set of sensors suitable for determining the presence and parking of a vehicle in the geographic domain, particularly by counting;
ii. a data aggregator suitable for retrieving the information generated by all the sensors and implementing steps (a) to (c) of the method;
iii. a repository comprising:
   a repository, known as the spatial repository, comprising a geographic description of the domain, and the parking area;
   a repository, known as the tariff repository, comprising the tariff ranges and their association with the parking area;
   a repository, known as the regulatory repository, comprising the regulatory provisions associated with the parking area;
iv. a module known as the application module suitable for implementing any of steps (d) to (l) of the method.

The device according to the invention can thus be adapted and configured around a common core for all urban situations and for all purposes of optimization or anticipation of mobility management. The use of a common architecture makes it possible to supplement and improve all the devices installed according to the particular feedback from each installation.

Advantageously, the device according to the invention comprises:
v. a module for providing formatted data from the data aggregator on the Internet.

Thus, some of the applications can be supplied by third parties in interaction with other data, for example for guiding motorists using their mobile geographical positioning terminals.

In an advantageous embodiment, the repository of the device according to the invention comprises:
a repository of rules defining the modalities of intervention of on-street parking enforcement officers.

Thus, said rules are used as part of optimization, subject to the constraints of the rounds of said officers.

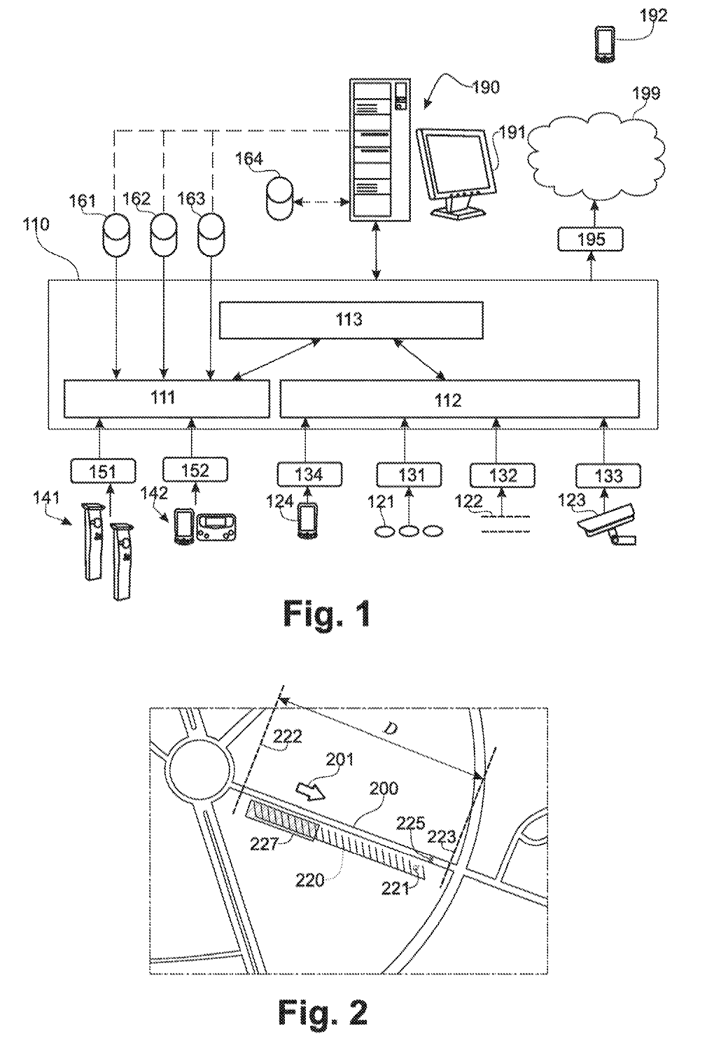

The invention is described below in its preferred embodiments, which are not limitative in any way, and by reference to FIGS. 1 to 9, wherein:

FIG. 1 is a schematic diagram of an exemplary embodiment of the architecture of the device according to the invention;

FIG. 2 is a top view of an exemplary map of a parking zone comprising an elementary section in an urbanized area;

FIG. 3 is an exemplary record of the occupancy of a parking area as a function of time, compared to the forecast provided by the counting module according to an exemplary embodiment of the device and method according to the invention;

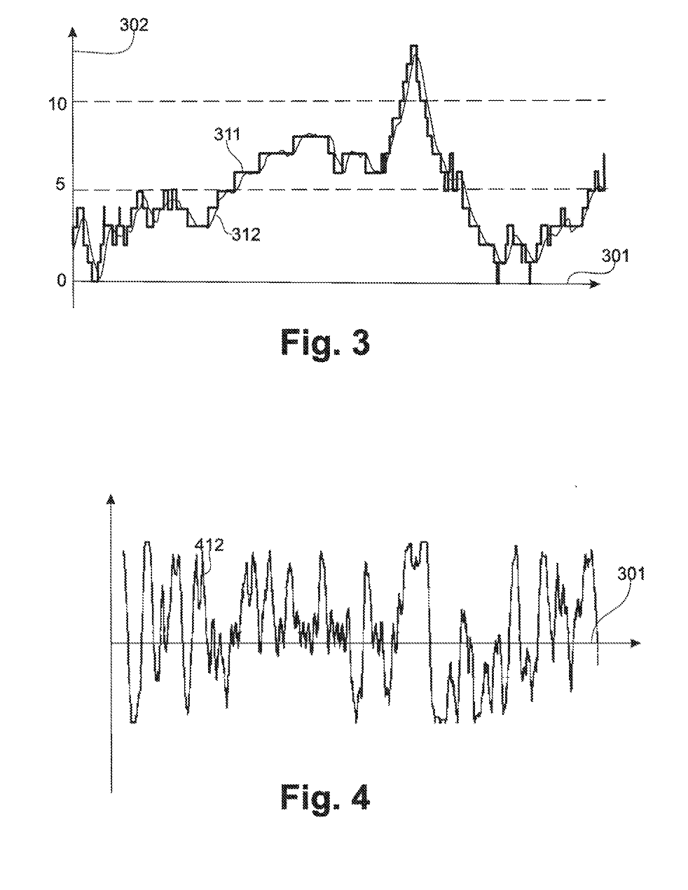

FIG. 4 is a time derivative of the interpolation function of FIG. 3;

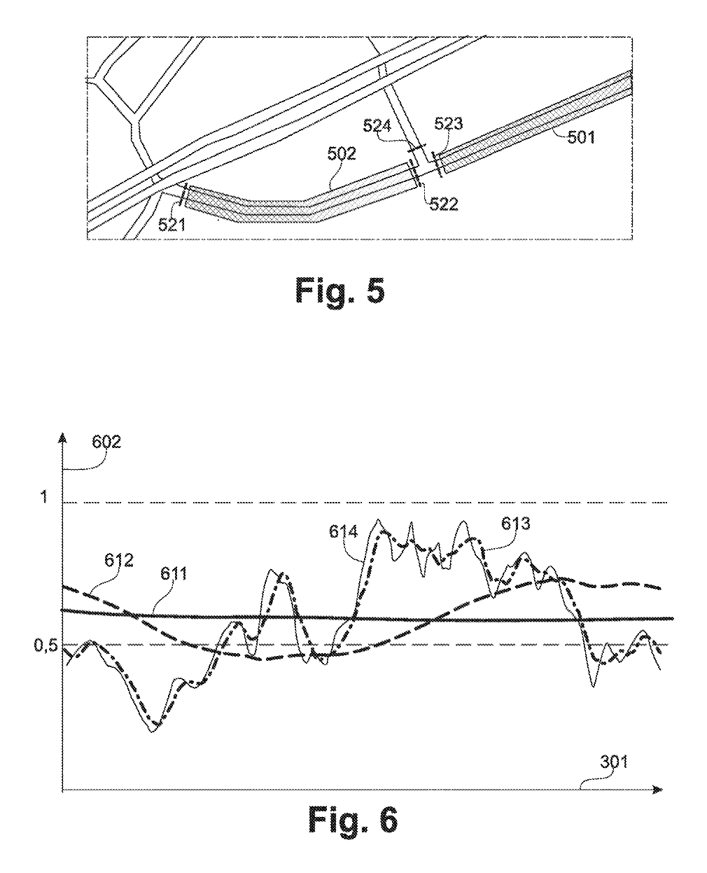

FIG. 5 is a top view of an exemplary parking zone comprising two elementary sections;

FIG. 6 is an exemplary change over time of the occupancy rate of a parking zone with different integration periods;

FIG. 7 is an exemplary change over time of the turnover rate of a parking zone with different integration periods;

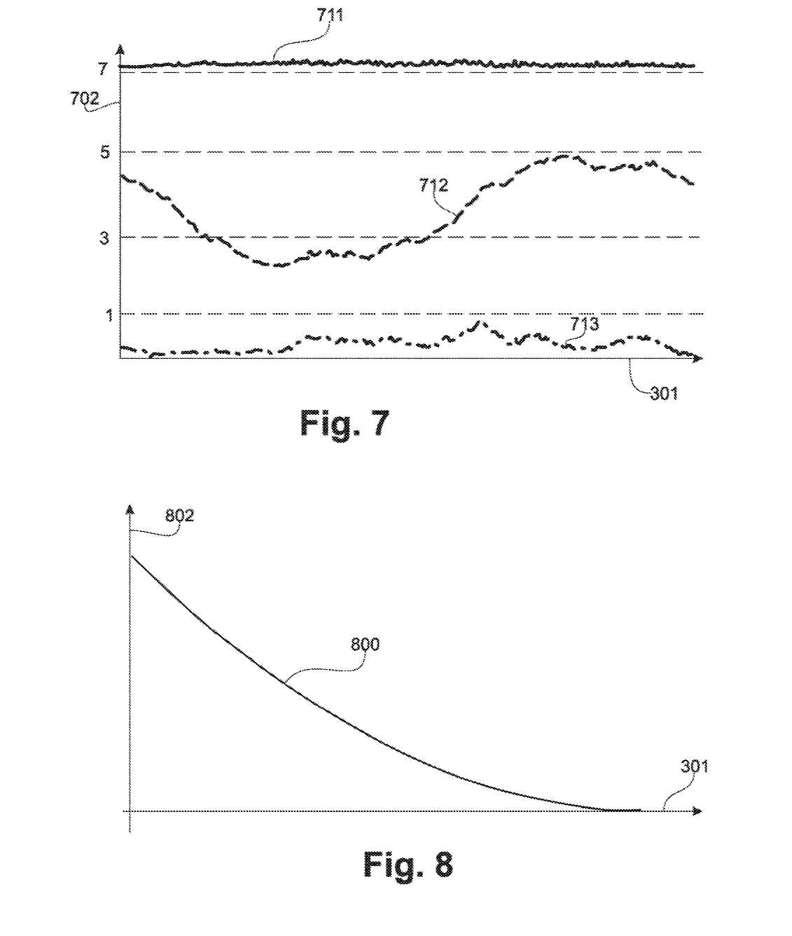

FIG. 8 is an exemplary change over time of the probability of finding a space in a given parking zone; and

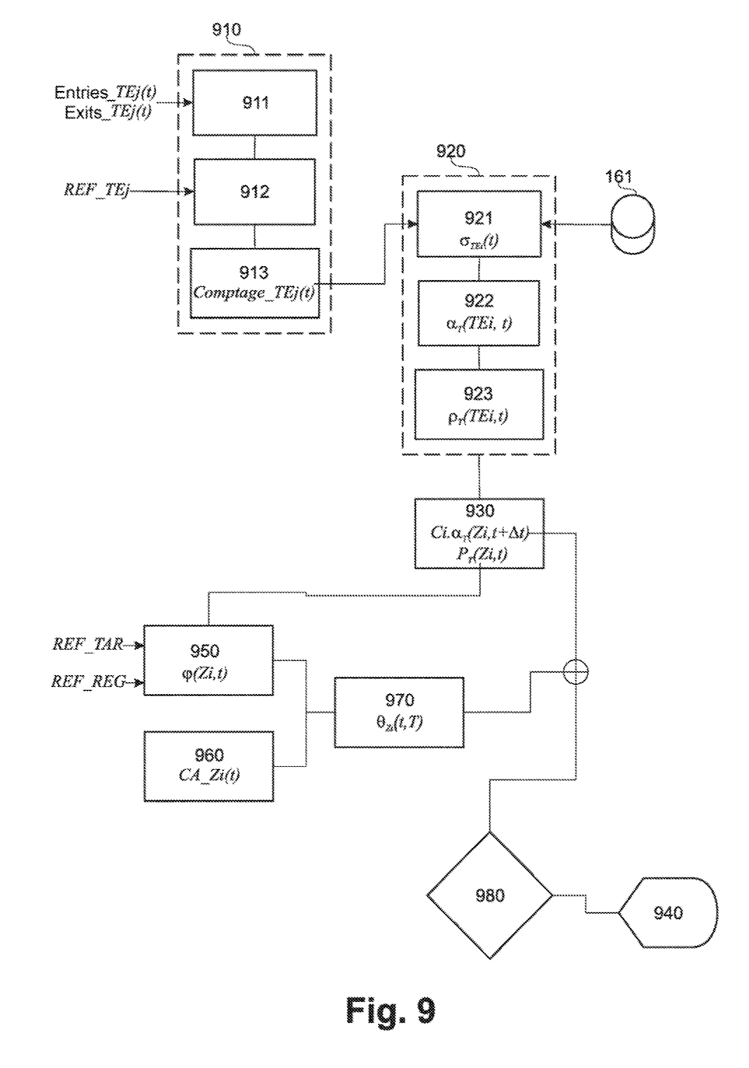

FIG. 9 is an organization chart of an exemplary embodiment of the method according to the invention.

FIG. 1, the method according to the invention is implemented by a computer using a device comprising a data aggregator (110). Said aggregator comprises a module (112), known as the DIC module, standing for Detection, Identification, Counting, suitable for collecting and interpreting the data from a first set of sensors installed in the geographic domain, to count the vehicles in said domain. These sensors are known in the prior art and principally consist in:
space-based parking sensors (121), which may be mechanical or magnetic;
video cameras (123), possibly comprising on-board algorithms for recognizing shapes or reading number plates;
counting and sequential detection sensors (122);
reporting applications based on mobile terminals (124) such as motorists' cell phones.

The above list is not exhaustive. As input, the DIC module (112) receives information from these sensors through concentrators (131, 132, 133, 134) that aggregate the statuses of said sensors and geographic information about their location in the parking area with suitable resolution. Also as input, the DIC module (112) receives information about the entry and exit of a vehicle into and from the relevant geographic domain. Depending on the embodiment, that information is provided by a dedicated set of sensors or by some sensors of the first set.

In one exemplary embodiment, the geographic domain is aggregated in 7 levels:
the town is the aggregate at the highest level for parking management;
the district is a homogeneous sub-part of the town;
the sector is a homogeneous sub-part of the district, which corresponds univocally to a finite list of pay & display machines;
the zone is a continuous geographic area with the same tariff and regulations; as a non-limitative example, an off-street parking facility is assimilated with a zone;
the elementary section is a portion of street that is limited by the center line of the street, the fronts that limit one side of the street and the two ends located at the intersections between the street and another street;
the space is a parking space which, as the case may be, is demarcated by marking on the ground or, if parking is free, is a division of the parking area into arbitrary segments.

Preferably, the counting of the entries and exits of vehicles is carried out on the scale of the elementary section. Thus, an elementary section does not comprise any intersection with another street, public or private, or with an off-street parking facility, public or private.

The data aggregator (110) comprises a module (111) known as a transactional module, intended for determining the revenue collected in relation to the occupancy of the parking area. As its input, that transactional module (111) firstly receives reference information that makes it possible to determine the tariff zones based on geography and time, and secondly receives payment information from both pay & display machines (141) and paperless payment methods (142).

The repository comprises three types of information:
a space repository (161), REF_SPA, which makes it possible to set up the geographical parking offer;
a tariff repository (162), REF_TAR, which makes it possible to define the tariff ranges associated with geographic zones and time slots;
a regulatory repository (163), REF_REG, which makes it possible to set up all the regulatory provisions associated with the different zones in question.

The device comprises data entry means (not shown) for setting up each of the repositories so as to create, delete or modify any part of the repositories and cover particular situations, such as road works, events or any type of exception in relation to nominal operating conditions. As its input, the tariff module (111) continuously receives payment information from pay & display machines (141) and paperless payment methods (142), via concentrators (151, 152) that aggregate payment data, time data and geographical data.

The DIC module (112) and the transactional module (111) transmit information collected from the different sensors, after interpreting and formatting them, to a computer (113) that processes the data for the intended applications. A control and decision-making center (190) makes it possible to supervise and manage the device. Thus, the transactional module (111) and the DIC module (112) build two independent items of information relating to the occupancy of the parking space: one relates to the actual occupancy and the other relates to the paid occupancy. By comparing those two items of information in real time according to specific protocols programmed in the computer (113) it is possible to obtain information about the effective occupancy status and the authorized occupancy status of the parking area, which information can be used by the control center (190) for different applications.

FIG. 2, according to an exemplary implementation, an elementary section (200), here made up of a street, comprises a plurality (220) of parking spaces. To simplify the description, said street is assumed to be a one-way (201) street. Said spaces are defined in the repository REF_SPA of the device according to the invention. In one exemplary embodiment, said repository REF_SPA is modified to take into account the neutralization of a series (227) of spaces, for example due to road works. Thus, the parking offer in the elementary section (200) is updated in real time in the device according to the invention.

In one exemplary embodiment, each space (220) has a presence sensor (not shown), which can detect whether or not it is occupied. Alternatively, the occupancy of a space is determined by one or more surveillance cameras (not shown).

In an alternative embodiment, the elementary section (200) comprises an entry sensor (222) and an exit sensor (223) separated by a distance D. This embodiment, which uses sequential counting, is particularly advantageous because it is simple to install and only requires counters at the entry to and exit from the elementary section. In this embodiment, two sensors inform a counter, programmed in the DIC module; the counter is incremented by one unit every time a vehicle enters and is decremented every time a vehicle leaves. If the street is not a one-way street, the sensors are capable to detect the direction of passage of the vehicle or are installed by half streets. This type of sensor is known in the prior art and consists, for instance, in an optical barrier or a mechanical device that is sensitive to the weight of the vehicle or a Doppler-effect radar, as a non-limitative list.

A vehicle that enters the elementary section (200) and is parked there only leaves said section after a time T_STAT very much longer than the transit time in said section.

The counting function is written:

$$Comptage\_TEj ( t ) = \frac{1}{T} {\int }_{- T}^{0} Entries\_TEj ( t + x ) - Exits\_TEj ( t + x ) ) d x - REF\_TEj$$

Where T is a time below or equal to T_STAT determined by experience or observation. Typically, T_STAT is equal to 30 minutes and T is equal to 10 minutes.

REF_TEj is the average number of vehicles simultaneously in transit in the elementary section in question.

FIG. 3, the observation of the number (302) of parked vehicles as a function of time (301) over a period of 12 hours shows the similarity of form of the function (312) Comptage_TEj (t) compared with the actual occupancy (311) of an elementary section including 20 parking spaces. Thus, even in the absence of space-based presence sensors, the setup of the function Comptage_TEj (t), for example using field observations, makes it possible to obtain a true image of the occupancy of the parking area. Thus, in this embodiment, the method according to the invention is advantageously implemented with a small volume of installations in the public space, which limits the cost of implementation. The model presented above is made with a fixed value for the parameter REF_TEj.

Advantageously, the value of REF_TEj is determined dynamically. Thus, the passage time T_LECT (i) of a vehicle i before one of the sensors (222, 223) at the entry to or exit from the zone enables to determine the speed of the vehicle when the length of said vehicle is known. Taking the statistical average length L of vehicles, for example 5.3 meters for traffic including automobiles, utility vehicles and heavy goods trucks, the average of that time with N vehicles provides a good approximation of the average transit speed.

FIG. 4, the observation of the time derivative (412), Comptage_TE′j (t) of the counting function (312 FIG. 3) shows that this is a finite-variance function, which can subsequently be broken down into a sum of sinusoidal functions.

$${Comptage\_TE}^{′} j ( t ) = {\sum }_{n} {a}_{n} \cdot cos ( {ω}_{n} \cdot t + {ϕ}_{n} )$$

The Fourier transform of the autocovariance function of that function makes it possible to identify, from the spectral density, the frequency f0 that corresponds to the dominant frequency of entry into the relevant zone. Thus there are:

$$REF\_TEj = f 0 \cdot \frac{D}{\overline{vitesse}}$$

$$\overline{vitesse} = \frac{1}{N} {\sum }_{1}^{N} \frac{L}{T\_LECT ( i )}$$

where D is the length of the relevant street section. Thus, the counting function is self-adjusted depending on the instantaneous measurement of traffic. Compared to the solutions of the prior art, the determination of the number of vehicles parked in an elementary section, and consequently, in a given geographic domain, is independent from all information relating to the payment of parking fees. As calculated from those data, the quantity of vehicles parked in the zone takes account both of vehicles that are regularly parked and also parked vehicles with no authorization or overstaying vehicles, and double-parked vehicles that are or not waiting for a space to become free, and vehicles that occupy a parking space for an excessively long period of time in view of the applicable legislation defined in the repository REF_REG. Thus, the method and device according to the invention make it possible, by comparing the actual occupancy rate with the theoretical capacity of the geographic domain, to detect, for example, the probability of double parking.

FIG. 9, according to this embodiment, the method according to the invention comprises a first step (910) aimed at determining the occupancy status of the relevant parking space, said step (910) comprises a first sub-step (911) consisting in determining the number of vehicles present in said parking area, for example by means of sequential counting that increments with entries and decrements with exits. In a second correcting sub-step (912), said sequential counting is corrected with the number of vehicles in transit, determined statically or dynamically. The information from these sub-steps (911, 912) is combined in a third sub-step (913) to determine the number of vehicles in the relevant parking area. That step (910) of determining the occupancy status of the parking area is implemented by the computer (113) of the data aggregator (110), from information derived from the DIC module (112).

The counting function described above makes it possible to calculate the instantaneous spatial occupancy rate of the relevant parking area. Thus, the instantaneous spatial occupancy rate a σ_{TEi} (t) of an elementary section is given, for example, by the relationship:

$${σ}_{TEi} ( t ) = \frac{Comptage\_TEi ( t )}{Ni}$$

Where Ni is the number of spaces in the relevant elementary section. That spatial occupancy rate compares the number of spaces available in the relevant section with the number of vehicles parked in said section.

The time occupancy rate α_{T} (TEi, t) or periodic occupancy rate of that area at an instant t and over a period T is given by:

$${α}_{T} ( TEi , t ) = \frac{1}{T} {\int }_{- T}^{0} {σ}_{TEi} ( t + x ) . d x$$

The time occupancy rate is thus the average occupancy rate over a period T.

The turnover rate ρ_{T} (TEi,t) of an elementary section TEi at an instant t over a reference period T is equal to half the number of status changes of the time occupancy rate of said elementary section over the period (t-T, t) put in relation with the number of spaces Ni of the section, or:

$${ρ}_{T} ( TEi , t ) = \frac{1}{2 Ni} {\int }_{- T}^{0} ‖ {σ}^{′} {T}_{Ei} ( t + x ‖ . d x$$

where σ_{TE} (x) is the time derivative of the considered spatial occupancy rate and thus provides the variation of that spatial occupancy rate over time. The turnover rate provides, over the period T, the average number of different vehicles that successively occupy the same parking space in the relevant elementary section.

FIG. 9, according to one exemplary embodiment, the second step (920) of the method according to the invention is essentially a computation step implemented by the computer (113) of the data aggregator (110), from the result of the previous step (910) and the data of the spatial repository (161) REF_SPA relating to the number of spaces in the relevant parking area. That second (920) computation step comprises, in this exemplary embodiment, a first (921) sub-step consisting in determining the spatial occupancy rate of the relevant parking area. The second (922) sub-step of the computation step (920) consists in determining the time occupancy rate of the parking area; this sub-step advantageously comprises the creation of a table of results that correspond to different periods of observation, or integration from a mathematical point of view. A third sub-step (923) of the computation step (920) makes it possible to determine the turnover rate of the relevant parking area. Advantageously, that sub-step (923) comprises the computation of a turnover table for different periods of observation.

FIG. 5, a parking zone is made up of several (501, 502) elementary sections. In an exemplary embodiment, each elementary section (501, 502) is demarcated by beacons (521,522, 523, 524) suitable for detecting the entry and the exit of a vehicle in each section. A given zone comprises, according to the mode of implementation, elementary sections fitted with space-based detection sensors and elementary sections equipped with sequential counting. Thus, the instantaneous occupancy rate α_{T} (Zi,t) of a zone Zi comprising several elementary sections is given by:

$${α}_{T} ( Zi , t ) = \frac{{\sum }_{j = 1}^{Nia} {α}_{T} ( TEj , t )}{Nia} + \frac{{\sum }_{j = 1}^{Nib} α ( TEj , t )}{Nib}$$

where Nia is the number of spaces instrumented with detection sensors and Nib is the number of non-instrumented spaces, the occupancy of which is determined by sequential counting as explained above.

Thus, the instantaneous turnover rate of the zone Zi for a reference period T is given by:

$${ρ}_{T} ( Zi , t ) = \frac{{\sum }_{j = 1}^{Nia} {ρ}_{T} ( TEj , t )}{Nia} + \frac{{\sum }_{j = 1}^{Nib} {ρ}_{T} ( TEj , t )}{Nib}$$

Thus, the average parking time length ω_{T} (Zi,t) in a zone Zi at an instant t and over a reference period T is given by:

$${ω}_{T} ( Zi , T ) = T . Min ( \frac{{α}_{T} ( Zi , t )}{{ρ}_{T} ( Zi , t )} , 1 )$$

and the average time length, Δ_{T} (Zi,t) of availability of a space in a zone Zi at an instant t and over the reference period T is provided by:

$${Δ}_{T} ( Zi , t ) = T . Min ( \frac{1 - {α}_{T} ( Zi , t )}{{ρ}_{T} ( Zi , t )} , 1 )$$

FIG. 6, according to an exemplary embodiment, the trend curve of the time occupancy rate (602) as a function of time (301) of a zone over a period of 24 hours depends on the period of reference T of observation. Thus, the occupancy rate (611) estimated over a 24-hour period T provides a rate that is substantially constant and close to 60% (0.6) according to this exemplary embodiment. An examination over a shorter period T, for example 12 hours (612), makes it possible to detect, for example, theoretical fluctuations in the relevant zone between the time slot of meter parking and the time slot of free parking. An examination over even shorter periods T, for example 1 hour (613) or 30 minutes (614) brings out the fluctuations of filling of the zone depending on the instant. The choice of the period T of observation depends on the use of those data. Thus, for macroscopic data aimed at supporting a decision relating to the installation of a parking zone, the monitoring of the occupancy rate over 24 hours and its trend depending on the days of the week or the month constitutes a relevant indication. On the other hand, to assess the instantaneous availability of a space in a geographic domain within a short time ΔT, the analysis over a shorter period T is more relevant.

Similarly, in FIG. 7, the trend of the turnover rate (702) of a geographic domain as a function of time (301) provides information with different relevance depending on the considered period T. Thus, the turnover rate (711) over a period of 24 hours shows that on average, over such a period, 7 vehicle changes occur in the same space. When the turnover rate is examined over a shorter period, for example 12 hours (712) or 1 hour (713), the turnover rate drops. Thus, the instantaneous occupancy rate, as such, can be used for example for determining the instantaneous probability of finding a space at an instant (t+Δt), where Δt is of the order of magnitude of the period of observation T, and also the change in that turnover rate as a function of the period of observation as shown in FIG. 7, provides information about the type of the zone, for example, if it is a zone with essentially residential occupancy, or a zone where occupancy is instead determined by commercial activity.

The applicant has thus determined that there is a direct relationship between the turnover rate of a zone Zi, its capacity Ci in number of spaces and the instantaneous probability P_{T} (Zi,t) for a motorist of finding a free space over a period of reference T.

FIG. 8, the applicant has thus determined that the greater the turnover rate ρ_{T} (Zi,t) of a zone, the more the likelihood of finding a free space is reduced as a function of the distance of the vehicle from said zone. Further, the journey time of the motorist up to said zone is substantially proportional with their distance from the zone, except in exceptional circumstances. Those probability data (802) depending on the context are thus modelled by a univocal mathematical function (800) and can thus be anticipated as a function of time (301).

As a non-limitative example, the following function has been tested on real cases and provides satisfactory results:

$${P}_{T} ( Zi , t ) = \frac{Ci}{{K}_{T}} \cdot \frac{{{ρ}_{T} ( Zi , t )}^{2}}{{α}_{T} ( Zi , t )}$$

where K_{T} is a constant of the zone Zi determined, for example empirically, by field observations.

All the information is recorded in real time in the memory means of the data aggregator. Thus, these data can be used later on for statistical purposes or to carry out simulations. Said information is also displayed in real time on display means (191, FIG. 1) of the control and supervision means, in order to deliver, in real time, geo-contextualized and time-stamped information about the occupancy of the parking area and the regular occupancy of the area. That information, combined with the capacities of simulation from the history of the information saved, makes the device and the method according to the invention a dynamic way of monitoring parking and mobility in the supervised urban setting.

For example, a comparison between the turnover in a zone over a 24-hour period with the average turnover rate of that zone, established from the history of said zone, makes it possible to detect the presence of a vehicle that has been parked for an inordinately long period of time in said zone.

From the dynamic point of view, the turnover rate defines, for a vehicle distant from a zone Zi, the probability of finding an available parking space in the relevant zone depending on the number of spaces that are free at an instant t. Thus, at a given instant t, a space is only available for a time Δt that depends on the instantaneous turnover rate. It is therefore unnecessary to guide a vehicle looking for parking to the relevant zone, if the travel time to that zone is greater than Δt and if there are few available spaces in said zone. As a result, at an instant t the relevant information for a motorist is:

Ci. α_{T} (Zi, t+Δt)

where Ci is the total capacity of the zone Zi and α_{T} (Zi, t+Δt) is the occupancy rate projected at (t+Δt).

The display of the availability of a parking zone, corrected by the average journey time, Δt, up to said zone, makes it possible to inform the motorist, who can optimize their choice themselves if they know the town. Said average travel time is determined either by the history of travelling observed in towns, or also dynamically. The information is advantageously displayed on variable notice boards installed in the urban area.

A problem does however occur for a motorist who does not know the town and for whom availability information alone, even with journey time correction, is not sufficient to make a relevant choice.

To that end, the method and device according to the invention make it possible to make an optimized choice and thus, for example, offer the user the choice of the most relevant parking zone depending on the context.

To that end, the information provided by the data aggregator is advantageously used to optimize real-time guidance for a motorist looking for a parking space.

Returning to FIG. 1, the information from the data aggregator (110) and particularly the information Δ_{T} (Zi,t) and ρ_{T} (Zi,t) is provided on the Internet (199), for different periods T of integration, through a specific module (195). As a non-limitative example, that information is provided for T=15 minutes, T=30 minutes, T=1 hour, T=2 hours. The data makes it possible to make an instantaneous forecast of the parking status in the geographic domain at a time (t+Δt), from data corresponding to the information provided by the data aggregator, such as Δt≦T, where Δt is of the order of magnitude of T. Thus, for Δt=10 minutes the data corresponding to a period T=15 minutes are used.

Thus, said data are retrieved free of charge or by subscription, by third parties who are capable of implementing and sharing dynamic guidance data with users, particularly through satellite positioning terminals and programs. Such applications are particularly capable of retrieving real-time traffic information through a variety of channels.

Guiding motorists to the most suitable parking zone is related to an optimization problem similar to the problem known as the travelling salesman problem and is solved by implementing optimization metaheuristics. Thus, the method and device according to the invention make it possible to collect data adapted for implementing such an optimization method.

In an exemplary embodiment, the metaheuristics used are those of ant colonies. Thus, for a motorist located at a distance from a parking zone that is such that a journey time Δt is necessary to go to that zone, said zone is defined by its visibility and its intensity. Its intensity represents the attractiveness of the zone. The higher the number of available spaces, the greater it is. Visibility is lower when the turnover rate of the zone, for a period of integration T close to Δt, is higher. The choice is determined by the weighted product of the visibility and the intensity of the different zones at an instant t.

The optimization methods using metaheuristics and particularly using ant colony algorithms are known in the prior art and those skilled in the art implement them from the indications above, namely by using the information Ci. α_{T}(Zi,t+Δt) for determining the instantaneous intensity of the zone Zi and the parameter P_{T}(Zi,t) for determining the instantaneous visibility of said zone Zi.

The device and method according to the invention are also advantageously used to organize enforcement in the parking area by on-street parking enforcement officers and by police forces.

That is because it is not of great use to guide on-street parking enforcement officers to a zone Zi, even if the number of spaces where fees are paid regularly is lower than the number of vehicles parked in said zone, if, within the time required by said officers to go to the zone, the parked vehicles have changed.

The data aggregator makes it possible to compute, from the data collected by the DIC module and the information of the repository REF_TAR, the theoretical revenue, φ (Zi,t), of a meter parking zone at an instant t; that instantaneous revenue is provided by:

$$ϕ ( Zi , t ) = Ni {\int }_{0}^{t} {α}_{u} ( Zi , t ) {\int }_{0}^{u} Zi . Tarif ( v ) . d v . d u$$

where Zi.Tarif (v) is the hourly tariff at the time v defined in the repository REF_TAR, and αᵤ(Zi,t) is the occupancy rate of the zone Zi at the instant t over the reference period u.

FIG. 9, the data derived from the computation step (920) are used in a characterization and anticipation step (930), implemented in this exemplary embodiment by the computing module (113) of the data aggregator (110) from models, to quantitatively characterize the parking area in question and particularly anticipate its future occupancy rate and associated probabilities. The data from the characterization and anticipation step (930), which are based on the information collected by the DIC module (112), are used in an exemplary embodiment in a computation step (950) of the theoretical revenue from the parking area. Advantageously, that computation step (950) is carried out for a value table of the period of observation. A step (960) of collecting and processing the information from pay & display machines and concentrators of payment methods, implemented by the transactional module (111), makes it possible to determine the effective revenue or sales from the parking area for different periods of observation.

Thus, the instantaneous sales CA_HOi (t) from a pay & display machine Hoi are provided by:

CA_HOi (t)=Σtransaction (j).montant

The summation is carried out on the number of transactions.

The instantaneous sales from a zone Zi, CA_Zi (t) are obtained by summing the sales from all the pay & display machines contained in said zone, and, where applicable, sales corresponding to other payment methods, over a period of reference u. The data are aggregated by the transactional module (111).

The recording of the information in real time in memory means of the data aggregator makes it possible to have statistics and, for example, integrate a forecast part in those sales, particularly in the presence of independent pay & display machines whose revenue status is only queried periodically.

FIG. 9, the sales from the parking area in question are compared (970) with the theoretical revenue from the same area and for the same period.

The comparison of the instantaneous theoretical revenue, prepared using the data from the DIC module, with the actual revenue established by the transactional module in the same zone, enables to define an instantaneous payment rate θ_{Zi} (t,T) over a reference period u=T:

$${θ}_{Zi} ( t , T ) = \frac{{CA}_{Zi} ( t )}{ϕ ( Zi , t )}$$

where CA_{Zi} (t) are the sales established by the transactional module in the relevant zone.

Thus, the data from the characterization and anticipation step (930) or data from the comparison (970) of the theoretical sales with the actual revenue are compared (980) with references for a given parking area and period of observation. Depending on the result of the comparison, information is displayed (940) for motorists, or on-street parking enforcement officers or for a supervisor.

Returning to FIG. 1, in one exemplary embodiment, an on-street parking enforcement officer has a mobile terminal (192) connected by radio link to the control and supervision center (190) of the device according to the invention. Thus, the display on the mobile terminal (192) of an enforcement officer of information about the instantaneous payment rate from a set of zones enables the officer to organize their rounds.

In another embodiment, the team of enforcement officers is managed by a supervisor. Said supervisor has, through the device according to the invention, real-time information about the occupancy of the parking area and the payment rate of the different zones Zi in that area, for example by means of a terminal (191) of the control center (190). Thus, said supervisor uses that information to manage the team of enforcement officers by communicating with said officers through their mobile terminals (192) or using any other means. However, at an instant t, said supervisor only has a finite number of enforcement officers and is further restricted by legal provisions, particularly those under labor legislation. For example, a team of enforcement officers going to a zone must be able to raise a penalty notice within a period compatible with their working hours, taking into account a return to the locker room where applicable. Thus, the control center (190) according to the invention advantageously has an application for optimizing the rounds of enforcement officers or assisting the supervisor of the teams in the organization of said rounds, based on the occupancy of the parking areas and other constraints. Thus, the device according to the invention comprises a repository (164), REF_ASVP, comprising the rules of intervention of on-street parking enforcement officers. Said repository comprises the constraints relating to the intervention of enforcement officers, such as:
legal and regulatory constraints derived from the provisions of labor legislation and collective bargaining agreements;
information about the availability of officers such as their working hours, leave periods or time off work;
the total hours already completed;
zones where enforcement is possible for an officer;
the minimum number of officers for enforcing parking regulations in a given zone Zi;
   the list above is not exhaustive.

Thus, the application aims to define the best allocation of officers on the basis of the occupancy of the parking area. This is a problem of optimization under constraint, which, in an exemplary embodiment, is solved by implementing an optimization metaheuristic such as an ant colony algorithm.

Thus, the round of the on-street parking enforcement officer can be modelled as a finite chain of journeys δj within the same zone and di between two zones.

Each journey di is characterized by a journey time σ_{di}:

$${σ}_{di} = \frac{Distance ( Zi , Zi + 1 )}{V}$$

where Distance (Zi,Zi+1) is the distance between two successive zones of the round and V is the average speed of travel of the officer.

Each journey δj is characterized by a journey time σ_{δj}:

σ_{δj}=Cj.(φ+ [symbol] .(1−θ_{Zj}(t,T)))

where [symbol] is the time required for preparing a penalty notice, φ is the time for travelling between two spaces and Cj is the capacity of zone Zj. Thus, with each journey di and δj corresponds to an economic efficiency ξ, where ξ(di) depends on the number of vehicles parked illegally and:

$$ξ ( δ j ) = {\int }_{t = 0}^{σ δ j} ( 1 - {θ}_{Zj} ( t , T ) ) d t$$

The travel efficiency for an officer is the relationship between the economic efficiency of the journey and the journey time. The real-time knowledge and archival of the data in the memory means of the data aggregator of the device according to the invention makes it possible to supplement the models by analyzing data and carrying out simulations, particularly by analyzing the data statistically.

Thus, the implementation of the optimization metaheuristic of the rounds of officers uses the inverse of the officer's journey time to the zone to inspect as the visibility of the zone and the efficiency of the journey to the zone as the intensity of said zone.

Returning to FIG. 2, the geographic domain comprises critical parking spaces, such as a space (221) set aside for persons with reduced mobility or a pedestrian crossing. These spaces are identified both in the space repository, REF_SPA, and in the regulatory repository REF_REG. As a non-limitative example, the particular spaces comprise:

spaces set aside for persons with reduced mobility;

spaces set aside for delivery vehicles;

spaces set aside for electric vehicles;

spaces set aside for vehicles transporting valuables;

spaces set aside for a particular category of user (police, diplomats etc.).

Advantageously, the parking zone (200) comprises specific sensors, for example one or more surveillance cameras to detect the presence of a vehicle at the critical spaces and possibly check if said vehicle is authorized to use such a space. As an example, the surveillance camera of the space (221) for persons with reduced mobility has the means to read the number plate of the vehicle or identify a special identifier on the windshield of said vehicle. Thus, the device according to the invention is capable of triggering an alert in the event of the improper use of a space (221, 225) that is reserved or forbidden. Further, the knowledge at any instant for a zone Zi of the information Ci. α_{T}(Zi,t+Δt) makes it possible, when the value drops below a definite threshold, to identify the risks of double parking in a given zone within a time Δt. Thus, the parking supervisor is capable of anticipating the sending of police officers to said zone to prevent that risk. With these possibilities of anticipation, the device and method according to the invention enable to increase the efficiency of all the personnel in charge of parking enforcement.

Returning to FIG. 1, the control and decision-making center (190) comprises a plurality of application modules to implement the embodiments described above. More particularly, in an advantageous exemplary embodiment, said control center comprises an application module suitable for modifying the tariff repository (162) on the basis of the information supplied by the data aggregator (110). Thus, the tariff offer is modified depending on the occupancy rate of the parking area in order to modify the turnover rate in some zones using dynamic adjustment as an incentive.

The description above and the exemplary embodiments show that the invention achieves the objectives sought. In particular, it makes it possible to dynamically manage the parking offer in a geographic domain by anticipating the occupancy rate and the turnover rate in a parking area from data acquired in real time. By separating the functions of counting and measuring the occupancy rate of the parking area from the functions of collecting parking fee payment data in that area, the system and device according to the invention make it possible to optimize enforcement in said parking area. The method according to the invention is easily implemented using counting markers, which can be installed easily on the street with no need for expensive works.

1-14. (canceled)

15. A device for supervising parking of vehicles in a geographic domain, comprising:
a set of sensors configured to determine presences and parking of vehicles in a parking area of the geographic domain;
a data aggregator configured to retrieve data generated by the set of the sensors and comprising a computer configured to perform statistical computations on the data;
a repository, in a digital form, comprising:
a spatial repository comprising a geographic description of the geographic domain and a parking area;
a tariff repository comprising tariff ranges and their association with the parking area;
a regulatory repository comprising regulatory provisions associated with the parking area; and
an application module configured to provide information to terminals.

16. The device according to claim 15, further comprising a module to provide formatted data from the data aggregator on the Internet.

17. The device according to claim 15, wherein the repository further comprises a rules repository comprising rules defining modalities of intervention of on-street parking enforcement officers.

18. The device according to claim 15, wherein the set of sensors determines the presence and parking of a vehicle in the parking area by counting.

19. A method for supervising parking of vehicles in a geographic domain using a supervising device comprising a set of sensors, a data aggregator, a repository and an application module, the method comprising the steps of:
obtaining an instantaneous occupancy status of a parking area of the geographic domain at a time t using the data aggregator, the sensors determines presence and parking of vehicles in the parking area, the data aggregator retrieves data generated by the set of the sensors, the data aggregator comprises a computer configured to perform statistical computations on the data, the repository, in a digital form, comprises a spatial repository comprising a geographic description of the geographic domain and the parking area, a tariff repository comprising tariff ranges and their association with the parking area, and a regulatory repository comprising regulatory provisions associated with the parking area;
obtaining an instantaneous turnover rate of parking over a period T in the parking area at a time t using the data aggregator;
computing a future occupancy rate and its probability at a time (t+Δt) from the instantaneous occupancy status and the instantaneous turnover rate;
providing information to terminals by the application module in response to a determination that the future occupancy rate or its probability is below or above a predefined threshold.

20. The method according to claim 19, wherein step of obtaining the instantaneous occupancy status further comprises the steps of:
obtaining a number of vehicles present instantaneously in the geographic domain;
obtaining an instantaneous number of vehicles in transit in the geographic domain; and
determining a number of vehicles parked in the geographic domain by subtracting the instantaneous number of vehicles in transit from the number of vehicles present instantaneously in the geographic domain

21. The method according to claim 19, wherein step of obtaining the instantaneous turnover rate further comprises the steps of:
obtaining a spatial occupancy rate of the geographic domain as a function of a number of vehicles parked in the geographic domain at the time t;
determining a time occupancy rate of the geographic domain over the period T as a function of an average spatial occupancy rate over the period T; and
determining a turnover rate of the geographic domain by averaging, over the period T, a variation of the time occupancy rate.

22. The method according to claim 19, further comprising the step of computing the future occupancy rate and its probability based on a journey time Δt to the geographic domain using optimization metaheuristics.

23. The method according to claim 22, wherein the metaheuristics use a random proportional transition rule derived from an ant colony algorithm and the information provided by the application module is built from a visibility of the geographic domain at the time (t+Δt).

24. The method according to claim 20, further comprising the step of determining an average speed of vehicles in a part of the geographic domain and determining a dominant time frequency of entry in the part of the geographic domain at the time t.

25. The method according to claim 21, further comprising the steps of obtaining a parking tariff grid in the geographic domain; and determining a theoretical revenue at the time t for the period T depending on the time occupancy rate of the geographic domain.

26. The method according to claim 25, further comprising the steps of obtaining an effective revenue of the geographic domain at the time t over a period of observation; and determining a payment rate of the geographic domain over the period of observation by comparing, in the period of observation, a relationship between instantaneous results of the effective revenue and the theoretical revenue.

27. The method according to claim 26, further comprising the steps of combining the future occupancy rate and the future occupancy probability with the payment rate information; determining a future payment rate at the time (t+Δt) and its probability; and providing payment information to the terminals by the application module in response to a determination that the future payment rate or its probability is below or above a given threshold.

28. The method according to claim 27, further comprising the step of determining the future payment rate and its probability based on a journey time Δt of an on-street parking enforcement officer to the geographic domain using optimization metaheuristics, the optimization metaheuristics uses a random proportional transition rule derived from an ant colony algorithm; and wherein the payment information is built from visibility of the geographic domain at the time (t+Δt).

29. The method according to claim 25, further comprising the step of modifying the parking tariff grid in accordance with the instantaneous occupancy status or the theoretical revenue.
